(19) United States
(12) Patent Application Publication
(10) Pub. No.: US 2024/0156118 A1
(43) Pub. Date: May 16, 2024

(54) METHOD FOR PRODUCING YOGURT, AND YOGURT PRODUCED THEREBY

(71) Applicant: Joon KWON, Seoul (KR)

(72) Inventor: Joon KWON, Seoul (KR)

(21) Appl. No.: 18/282,416

(22) PCT Filed: May 25, 2022
(86) PCT No.: PCT/KR2022/007405

§ 371 Date: Sep. 15, 2023

(30) Foreign Application Priority Data
Aug. 31, 2021 (KR) 10-2021-0115192
May 23, 2022 (KR) 10-2022-0062596

(51) Int. Cl. A23C 9/123; A23C 9/133

(52) U.S. Cl. CPC A23C 9/123; A23C 9/133; A23V 2400/11

(57) ABSTRACT

A method for producing yogurt includes steps of: (a) producing a lactic acid bacteria-containing fermentation broth by adding live lactic acid bacteria to a yogurt raw material and fermenting the yogurt raw material; and (b) producing a killed bacteria-containing liquor by killing the live lactic acid bacteria through a process of heat-treating the live lactic acid bacteria-containing fermentation broth. According to the method, it is possible to solve distribution and storage problems by dramatically overcoming the limitation of short shelf life under refrigerated storage conditions of existing yogurt, specifically, increasing the shelf life at room temperature (not refrigeration) of yogurt to at least 6 months, preferably about 1 year, while maintaining the taste, nutritional components, and special features of existing yogurt, through a process of fermenting a raw material using live lactic acid bacteria and killing the live lactic acid bacteria by heat treatment.

### TECHNICAL FIELD

The present invention relates to a method of producing yogurt with a significantly increased shelf life through a process of adding live lactic acid bacteria to ferment a raw material and then killing the lactic acid bacteria, and to yogurt produced thereby.

### BACKGROUND ART

Currently, globally, yogurt is made by fermenting yogurt raw material using live lactic acid bacteria, and thus has a problem in product distribution in that the shelf life thereof is only 2 to 3 weeks (1 month for Greek yogurt) under refrigeration, despite the special features thereof. Due to this distribution problem, it is actually impossible to export produced yogurt around the world.

In addition, research results indicate that ingestion of live lactic acid bacteria not only has a beneficial effect on the human body, but also has the disadvantage of being able to cause instability of the human immune system due to the side effects of lactic acid bacteria.

Therefore, the present applicant proposes a method for producing yogurt that can overcome the limitation of shelf life, which is the biggest disadvantage of existing yogurt containing live lactic acid bacteria, while maintaining the special features of the existing yogurt.

### DISCLOSURE

### Technical Problem

The present invention has been made in order to solve the above-mentioned problems occurring in the prior art, and an object of the present invention is to provide a method for producing yogurt that is capable of solving distribution problems by dramatically overcoming the limitation of short shelf life of existing yogurt, specifically, increasing the room-temperature shelf life of yogurt (1 month or less under refrigeration for existing yogurt) to at least 6 months, preferably 1 year or more, without changes in product quality and sensory properties, while maintaining the special features of existing yogurt, through a process of fermenting a raw material using live lactic acid bacteria and killing the live lactic acid bacteria by heat treatment, and yogurt produced by the method.

### Technical Solution

In accordance with one aspect of the present invention, there is provided a method for producing yogurt including steps of: (a) producing a live lactic acid bacteria-containing fermentation broth by adding live lactic acid bacteria to a yogurt raw material and fermenting the yogurt raw material; and (b) producing a killed bacteria-containing fermentation broth by killing the live lactic acid bacteria through a process of heat-treating the live lactic acid bacteria-containing fermentation broth at least once.

The heat treatment is preferably performed within a range of temperature and time conditions in which no change in nutritional components of the live lactic acid bacteria-containing fermentation broth occurs.

The heat treatment in step (b) may be performed at a temperature of 80° C. to 100° C. for 10 minutes to 40 minutes.

The heat treatment in step (b) may be performed at least twice sequentially.

The yogurt raw material may be milk or a vegetable milk substitute including at least one of coconut cream and soy milk.

Step (b) may be performed in a state in which the live lactic acid bacteria-containing fermentation broth is accommodated in a chamber so that it is protected from contact with external air, and the method may further include, after step (b), a step of stirring the killed bacteria-containing fermentation broth in the chamber.

The method may further include, after step (b), step (c) of additionally heat-treating the killed bacteria-containing fermentation broth in a state in which only the killed bacteria-containing fermentation broth is packaged in an individual container, or additionally heat-treating a mixture of the killed bacteria-containing fermentation broth and a fruit additive in a state in which the mixture is packaged in an individual container.

The heat treatment in step (c) may be performed at a temperature of 80° C. to 95° C. for 10 minutes to 40 minutes.

Step (c) may be performed in a state in which a predetermined amount of killed bacteria are added to the individual container.

### Advantageous Effects

According to the present invention, it is possible to solve distribution and storage problems by dramatically overcoming the limitation of short shelf life of existing yogurt, specifically, increasing the room-temperature (not refrigeration) shelf life of yogurt to at least 6 months, preferably about 1 year, while maintaining the nutritional components and special features of yogurt.

In addition, by performing the process of fermenting a raw material using live lactic acid bacteria and killing the live lactic acid bacteria by heat treatment, the produced yogurt may be distributed without being significantly affected by temperature changes during distribution, and when taken ingested, it may move to the intestines without being affected by gastric acid, bile and the like, suppress harmful bacteria in the intestines, protect the intestines, and enhance immunity. In addition, it may have improved safety, such as reduced antibiotic resistance transfer, and may be easily processed, packaged, distributed, and taken compared to existing probiotics.

Due to these effects, it is possible to increase the stability of the yogurt food and to distribute the same at room temperature, thereby increasing the domestic shelf life and enabling global distribution, thus creating high added value. In addition, it is possible to achieve the goals of reducing carbon emissions, preventing resource waste, increasing efficiency, and promoting animal welfare, in line with the trend of ESG management, and at the same time, it is possible to distribute the yogurt food at room temperature, thereby achieving the UN's sustainable goal of relieving the hunger of low-income and poor people living in poor living conditions in the world and promoting health.

### BRIEF DESCRIPTION OF DRAWINGS

FIG. 1 is a flow chart showing a method for producing yogurt according to an embodiment of the present invention.

FIG. 2 shows photographs of the products produced in Comparative Example 1, Example 1, which is the method for producing yogurt according to an embodiment of the present invention, and Comparative Example 7.

FIG. 3 is a table comparing the appearances, pHs, tastes, bacterial counts, and viscosities of the products produced in Examples 1 and 2, which are the method for producing yogurt according to an embodiment of the present invention, and Comparative Examples 1 to 7.

FIG. 4 is a table comparing the nutritional components of the products produced in Comparative Example 1, Example 1, and Comparative Example 7.

FIGS. 5 and 6 are graphs showing changes in each component after preparing a sample of Example 1 and storing the sample of Example 1 under refrigeration and room temperature conditions for 3 months.

FIGS. 7 and 8 are graphs showing changes in each component after preparing a sample of Example 2 and storing the sample of Example 2 under refrigeration and room temperature conditions for 3 months.

### BEST MODE

Hereinafter, embodiments of the present invention will be described in more detail with reference to the accompanying drawings. However, the present invention is not limited to the embodiments disclosed below and may be embodied in a variety of different forms. Rather, these embodiments are provided so that the disclosure of the present invention will be thorough and complete, and will fully convey the scope of the present invention to those skilled in the art. In the drawings, like reference numerals designate like elements.

According to a method for producing yogurt according to a preferred embodiment of the present invention and yogurt produced thereby, it is possible to solve distribution problems by dramatically overcoming the limitation of short shelf life of existing yogurt, specifically, increasing the room-temperature shelf life of yogurt to at least 6 months, preferably about 1 year, while maintaining the special features of existing yogurt, through a process of fermenting a raw material using live lactic acid bacteria and killing (parabiotics) live lactic acid bacteria (probiotics) by heat treatment.

That is, various side effects in the human body that occur after ingesting live lactic acid bacteria appear due to metabolites generated during the ingestion and metabolization of nutritional components in the human body by microorganism. It would be said that killed lactic acid bacteria, which have been inactivated so as to be unable to proliferate no longer while maintaining the useful components of live lactic acid bacteria, are absolutely safe even if they are ingested in huge numbers of hundreds of billions or more. In addition, since the killed lactic acid bacteria have been inactivated so that they cannot cause abnormalities due to decay or overgrowth, the room-temperature shelf life of yogurt containing the killed lactic acid bacteria may be maintained for a long period of at least 6 months, preferably 1 year or more.

Hereinafter, the present invention will be described in detail with reference to embodiments.

Briefly, killing bacteria is a process of inactivating lactic acid bacteria so as to be unable to proliferate by changing the shape of lactic acid bacteria cells, such as degrading cell wall components. Various studies have reported that killed lactic acid bacteria have health benefits similar to those of live lactic acid bacteria. The cell walls of lactic acid bacteria are hydrolyzed by heat in the bacteria killing process so that the particle size of the lactic acid bacteria becomes smaller. Thus, the killed lactic acid bacteria are absorbed in the small intestine at a higher rate than the live lactic acid bacteria, and exhibit excellent efficacy in the human body.

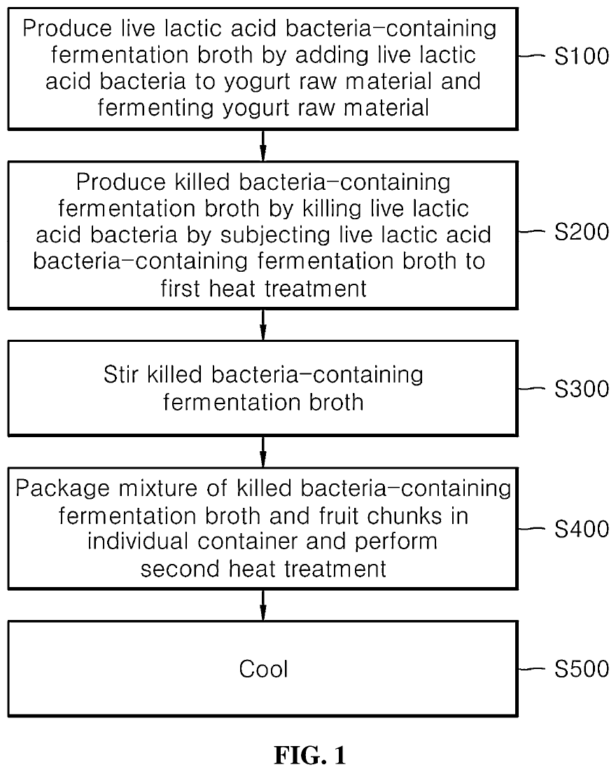

As shown in FIG. 1, the method for producing yogurt according to an embodiment of the present invention includes: step (S100) of producing a live lactic acid bacteria-containing fermentation broth; step (S200) of producing a killed bacteria-containing fermentation broth through heat treatment; step (S300) of stirring the killed bacteria-containing fermentation broth; and additional heat treatment step (S400).

First, as shown in FIG. 1, a live lactic acid bacteria-containing fermentation broth is produced by adding live lactic acid bacteria to a yogurt raw material and fermenting the yogurt raw material (S100).

In the present invention, the yogurt raw material may be milk or a vegetable milk substitute containing at least one of coconut cream and soy milk. In the embodiments described below, description will be made based on coconut vegan yogurt which is produced using coconut cream as a yogurt raw material.

In the present invention, step S100 is performed in a state in which live lactic acid bacteria are introduced into a chamber containing approximately several hundred kg of the yogurt raw material. As the live lactic acid bacteria, probiotics are used.

Specifically, examples of the live lactic acid bacteria used include, but are not limited to, Lactobacillus bulgaricus (KCTC 3188), Streptococcus thermophiles (KCTC 3658), Leuconostoc kimchii (KCTC 0651), Leuconostoc citreum (KCTC 3526), Leuconostoc mesenteroides (IMSNU 10146), Leuconostoc gasicomitatum (KCTC 3753), Leuconostoc lactis (KCTC 3528) Lactobacillus plantarum (KCTC 10123), Lactobacillus sakei (IMSNU 10130), Lactobacillus acidophilus (KCTC3145), Bifidobacterium longum (KCTC 3421), Streptococcus thermophilus (KCTC 3658), Lactobacillus bulgaricus (IMSNU 13005), and the like.

In the present invention, live lactic acid bacteria are added to coconut cream, which is one of yogurt raw materials, and is subjected to an acidification process through fermentation, whereby the pH may be lowered to 3.6 to 4.0, which is a satisfactory condition for increasing the room-temperature shelf life of food to about 1 year.

Specifically, coconut cream is sterilized before being inoculated with live lactic acid bacteria. This is to facilitate the proliferation of live lactic acid bacteria as inoculum by removing other bacteria that may exist in the coconut cream and the incubator (chamber). The sterilized coconut cream is inoculated with one of the lactic acid bacteria species specified above, and is fermented at 37° C. for 48 to 72 hours. The end point of fermentation is set to the point at which the fermentation broth reaches a pH of approximately 3.6 to 4.0.

To elaborate, in general, coconut cream has a pH of 6.0 to 6.5, and thus when yogurt is produced using coconut cream itself, a problem arises in that it is very difficult to maintain the room-temperature shelf life of the product at one year under normal circumstances. However, when coconut cream is inoculated with live lactic acid bacteria and subjected to a fermentation process, the coconut cream is acidified by organic acids generated during the metabolism of the live lactic acid bacteria, so that the pH of the live lactic acid bacteria-containing fermentation broth (coconut yogurt stock) decreases to about 3.6 to 4.0, which is a prerequisite for producing products with a room-temperature shelf life of 1 year.

In addition, acidification (pH reduction) of the product through fermentation can bring about the following effects.

First, since organic compounds such as vitamins generated through microbial metabolism (fermentation) are more stable under acidic conditions, organic compounds such as vitamins may be more abundant than before fermentation despite the application of water and heat, and create the basic requirements for extending the shelf life. In general, when the pH is 4 or less, the room-temperature shelf life is measured to be one year, and accordingly, a basis for extending the shelf life may be ensured without additional additives such as alcohol or preservatives.

In an embodiment of the present invention, a process of heating the yogurt raw material to a high temperature may be added before performing step S100. That is, a process of heating the yogurt raw material to a high temperature may be performed before fermenting the yogurt raw material by adding live lactic acid bacteria thereto. Thus, other bacteria that may be present in the yogurt raw material may be removed, thereby providing a base environment in which only lactic acid bacteria as inoculum may proliferate and the yogurt raw material may be fermented.

Next, as shown in FIG. 1, a killed bacteria-containing fermentation broth is produced by killing the live lactic acid bacteria through a process of heat-treating the live lactic acid bacteria-containing fermentation broth (S200).

In step S200, as in step S100 described above, a continuous operation is performed in a facility such as a chamber, a tank, or a mixing tank composed of multiple jackets so that the live lactic acid bacteria-containing fermentation broth after fermentation is protected from contact with external air.

In general, existing live lactic bacteria yogurt does not undergo heat treatment, and thus during the product distribution process, the live lactic acid bacteria in the yogurt ferment excessively, or fungi (mold, yeast, etc.) introduced together with the live lactic acid bacteria decay. Thus, the existing live lactic bacteria yogurt has a fundamental limit in that the shelf life is only 2 to 3 weeks even under refrigeration conditions at 0 to 10° C.

On the other hand, according to the present invention, after completion of the fermentation process using live lactic acid bacteria, the fermentation broth is heat-treated to heat-kill the live lactic acid bacteria (probiotics), thereby preventing the product to further ferment in the distribution process. Thus, it is possible to increase the shelf life of yogurt to about 1 year or more under room temperature conditions, rather than refrigeration conditions in which existing yogurt is distributed, while maintaining the special features of existing yogurt as a fermented food.

In the present invention, after fermentation of the yogurt raw material by live lactic acid bacteria is performed to a predetermined extent or more, a process of killing the live lactic acid bacteria by heat treatment is performed.

In the present invention, killed bacteria are not directly added to the yogurt raw material, but the yogurt raw material is fermented using live lactic acid bacteria and then the live lactic acid bacteria are killed. The present invention has advantages described below compared to the case in which killed bacteria are directly added.

If killed bacteria are directly added to the yogurt raw material, the special features and characteristics of the yogurt produced through fermentation cannot be realized because the process of fermenting the yogurt raw material is omitted. In addition, the above-described process of lowering the pH to 4.0 or less, which is an essential condition for room-temperature distribution, through fermentation, is omitted, and thus other method must be performed for room-temperature distribution. In addition, since killed bacteria are generally in powder form, the killed bacteria in powder form may be inevitably exposed to external air during the introduction process. Also, it is difficult to ensure uniform dispersion of killed bacteria in powder form in the process of producing a yogurt stock by adding the killed bacteria and filling the yogurt stock in small amounts into individual containers (cup form) to be purchased by consumers to make a final product, and thus there is a disadvantage in that it is quite difficult to maintain the content of killed bacterial per individual container at a constant level (e.g., 50 billion CFU, etc.).

However, in the present invention, after fermentation using live lactic acid bacteria, the characteristics of the live lactic acid bacteria-containing fermentation broth are made to be substantially the same as those of existing yogurt products for refrigerated storage, and then an additional process of heat-treating the live lactic acid bacteria-containing fermentation broth to kill the live lactic acid bacteria is performed. Thus, the shelf life of yogurt as a fermented food may be dramatically increased to one year or more at room temperature while maintaining the same special features of the yogurt as those of existing yogurt.

In addition, in the present invention, the live lactic acid bacteria-containing fermentation broth is heat-treated in a chamber having an internal space that may be blocked from external air or in a space closed to the outside, and thus it is easy to maintain the content of killed cells at a constant level equivalent to a predetermined level. Thus, unlike the above-described method in which killed bacteria are directly added, it is possible to stably produce a product with uniform quality by maintaining the content of killed bacteria per individual container at a constant level (e.g., 50 billion CFU, etc.).

In addition, according to the present invention, it is possible to produce a yogurt product that differentiated through the advantages of killed bacteria over live lactic acid bacteria, because the product contains killed live lactic acid bacteria.

To elaborate, the advantages of killed live lactic acid bacteria (heat-killed probiotics) over live lactic acid bacteria (probiotics) are as follows.

Killed bacteria are not alive in the killed bacteria-containing fermentation broth due to heat treatment, but many data demonstrate that killed bacteria have a beneficial effect on human health. For example, killed bacteria have effects similar to live lactic acid bacteria, have excellent safety, exhibit stable efficacy, have an extended shelf life, and do not have problems such as antibiotic resistance transfer.

In addition, live lactic acid bacteria have a particle size of 2 to 20 μm, are difficult to pass through microfold cells in the small intestine of the human body, and thus may have a low absorption rate in the small intestine. However, in the case of heat-treated lactic acid bacteria (killed bacteria), during the bacteria killing process, the particle size becomes relatively smaller than that of live lactic acid bacteria through processes such as degradation of cell wall components, and the immunomodulatory components in the cell wall are changed into a form that is more easily absorbed. Thus, the killed bacteria have advantages in that they may pass through microfold cells of the small intestine, have a relatively high absorption rate in the small intestine, and thus have an excellent effect of activating the human immune system.

In addition, the heat-treated lactic acid bacteria have biologically active functions such as immunomodulation, pain response control, allergic disease treatment, and cholesterol lowering, which are equal or similar efficacy to those of live lactic acid bacteria, as revealed through numerous research results.

In the present invention, the heat treatment for killing live lactic acid bacteria is preferably performed within a range of temperature and time conditions in which no change in nutritional components of the live lactic acid bacteria-fermentation broth occurs. Specifically, the heat treatment in step S200 is performed at a temperature of 80° C. to 100° C. for 10 minutes to 40 minutes.

Preferably, the heat treatment may be performed at a temperature of 80° C. to 95° C. for 10 minutes to 30 minutes, and more preferably, may be performed at a temperature of 85° C. to 90° C. for 10 minutes to 20 minutes. The fact that no changes in nutritional components occur even when such heat treatment is performed will be further explained with reference to examples to be described later.

Regarding the heat treatment conditions, if the heat treatment is performed at a temperature below 80° C., a big problem may arise in that the live lactic acid bacteria are not completely killed, and thus the bacteria remain in the fermented yogurt broth, making it impossible to expect a room-temperature shelf life of about one year, which is sought in the present invention.

In addition, at a temperature below 80° C., the time required to kill the microorganism may inevitably increase due to the initial number of microbial cells contained in the fermented yogurt broth. If this heating (sterilization) for a long time is performed batchwise in a tank rather than being performed through a heat exchanger, it may cause quality problems due to color change and layer separation of the fermented yogurt broth.

In addition, if the heat treatment is performed for less than 10 minutes, a big problem may arise in that the live lactic acid bacteria are not completely killed, and thus the bacteria remain in the fermented yogurt broth, making it impossible to expect a room-temperature shelf life of about 1 year for the final yogurt product.

In addition, if the heat treatment is performed at a temperature higher than 100° C., a problem may arise in that the color change (change from light brown to dark brown) of the fermented yogurt broth occurs, causing consumer rejection.

In addition, heat treatment at a temperature higher than 100° C. is usually performed through heat exchange using UHT facilities, and this case, disadvantages occur in terms of economic efficiency due to the nature of expensive UHT facilities that require additional equipment such as a back pressure unit and a deaerator. In addition, if the heat treatment is performed at a temperature higher than 100° C., destruction of nutritional components such as vitamins contained in the fermented yogurt broth may additionally occur.

However, in the present invention, as a temperature of 80° C. to 100° C. is applied, the first sterilization of the fermented yogurt broth may be performed efficiently in terms of time and cost, if there is only a tubular type HTST facility among heat exchangers.

In addition, when the heat treatment is performed for more than 40 minutes, there is no significant difference in terms of results between heat treatment for 40 minutes and heat treatment for more than 40 minutes. Thus, it is desirable to increase production efficiency by further shortening the heat-treatment time in the production process.

In an embodiment of the present invention, the heat treatment process in step S200 is performed at a temperature of 80° C. to 100° C. for 10 minutes to 40 minutes, and may be performed once or performed at least twice sequentially.

In one embodiment, the applicant of the present invention performed the heat treatment in step S200 twice through two steps, and performed the heat treatment in step S400 described later once, thereby performing heat treatment a total of three times.

For example, as described in Example 2 below, a live lactic acid bacteria-containing fermentation broth was heat-treated at 80° C. for 10 minutes (first heat-treatment, step S200), and the fermentation broth heat-treated at 80° C. for 10 minutes was further heat-treated at 90° C. for 10 minutes (second heat-treatment, step S200), thereby producing coconut vegan yogurt.

Here, the heat-treatment step at 80° C. for 10 minutes corresponds to the preheating and sterilization process of the entire process for killing the live lactic acid bacteria of the live lactic acid bacteria fermentation broth, and the additional heat-treatment step at 90° C. for 20 minutes corresponds to the main sterilization process for substantially killing the live lactic acid bacteria, and at the same time, ensuring food safety so that the killed bacteria-containing fermentation broth is not spoiled by microorganisms, including fungi. By performing step S200 in two sequential steps in this way, it is possible to further optimize and maximize the effect of killing bacteria.

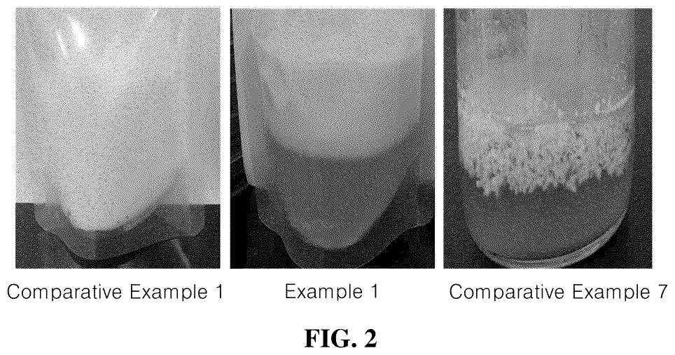

As will be described below, as a result of producing a killed bacteria-containing fermentation broth by producing a live lactic acid bacteria-containing fermentation broth using coconut cream as a yogurt raw material and killing the live lactic acid bacteria, as shown in FIG. 2, the present applicant confirmed that the killed bacteria-containing fermentation broth had an increased viscosity compared to a general live lactic acid bacteria-containing yogurt product, and thus showed an appearance similar to that of Greek yogurt.

Therefore, the method according to the present invention further includes, after step S200, step S300 of stirring the killed bacteria-containing fermentation broth in the chamber as shown in FIG. 1 so that layer separation of the killed bacteria-containing fermentation broth contained in the chamber does not occur.

Next, as shown in FIG. 1, after step S300, in order to produce plain-type yogurt, only the killed bacteria-containing fermentation broth is additionally heat-treated in a state in which it is packaged in an individual container, or a mixture of the killed bacteria-containing fermentation broth and a fruit additive is sterilized by additional heat treatment in a state in which the mixture is packaged in an individual container (S400). The fruit additive may be any one of fruit chunks (mango, blueberry, etc.), purees, juice, or a mixture thereof.

This second heat treatment in step S400 is capable of additional sterilization of the killed bacteria-containing fermentation broth, sterilization of the fruit additive, prevention of re-contamination of the killed bacteria-containing fermentation broth produced through the first heat treatment in step S200, and additional sterilization of the yogurt container and sealing paper.

The heat treatment in step S400 is a second heat treatment process that is performed after the first heat treatment (performed once or at least twice) in step S200. It is also performed at a temperature of 80° C. to 95° C. for 10 minutes to 40 minutes.

If the heat treatment in step S400 is performed at a temperature lower than 80° C., a big problem may arise in that the fresh additive such as fruit chunks is not perfectly sterilized, which may cause spoilage and makes it impossible to expect a room-temperature shelf life of about one year, which is sought in the present invention. In addition, a problem may arise in that germs that may remain in the container, the packaging film, etc. are not sterilized, and thus the killed bacteria-containing fermentation broth that has ensured a room-temperature shelf life of about one year through the above-described step S200 may also spoil.

In addition, if the second heat treatment is performed for less than 10 minutes, a big problem may arise in that, due to insufficient sterilization of the fruit additive, it is impossible to expect a room-temperature shelf life of about 1 year for the final yogurt product. In addition, a problem may arise in that germs that may remain in the container, the packaging film, etc. are not sterilized, and thus the killed bacteria-containing fermentation broth that has ensured a room-temperature shelf life of about one year through the above-described step S200 may also spoil.

In addition, if the second heat treatment is performed at a temperature higher than 95° C., a problem may arise in that the color change (change from light brown to dark brown) of the mixture of the killed bacteria-containing fermentation broth and fruit chunks occurs, causing consumer rejection. In addition, if the second heat treatment is performed at a temperature higher than 95° C., a problem may arise in that a pin hole may be generated in the individual container due to an increase in the internal pressure of the individual container, and external air may enter the inside of the individual container through the pin hole.

Additionally, when the second heat treatment is performed at a temperature higher than 95° C., destruction of nutritional components, particularly vitamins, contained in the fruit chunks or puree, may occur.

In addition, when the second heat treatment is performed for more than 40 minutes, there is no significant difference in terms of results between heat treatment for 40 minutes and heat treatment for more than 40 minutes. Thus, it is desirable to increase production efficiency by further shortening the heat-treatment time in the production process. In addition, if the second heat treatment is performed for a long time exceeding 40 minutes, problems may arise, such as color or sensory (quality) deterioration of yogurt contents, and destruction of vitamins.

On the other hand, step S400 may be performed in a state in which a certain amount of killed bacteria are added to the individual container. That is, in order to produce plain-type yogurt, a mixture containing a certain amount of killed bacteria added to the killed bacteria-containing fermentation broth may be heat-treated in a state in which it is packaged in an individual container, or a mixture containing a certain amount of killed bacteria added to the mixture of the killed bacteria-containing fermentation broth and the fruit additive may be heat-treated in a state in which it is packaged in an individual container.

Next, as shown in FIG. 1, the product subjected to the second heat treatment in step S400 is cooled to a temperature of 30° C. or below (S500). In addition, the central portion of the yogurt broth packaged in the packaging container is cooled to a temperature of about 30° C. or less.

Hereinafter, the present invention will be described in more detail with reference to examples and experimental examples.

### Example 1: Production of Heat-Killed Lactic Acid Bacteria-Containing Fermentation Broth (Step S200, Performed Once)

Coconut cream as a yogurt raw material was placed in a chamber, and Dupont's Danisco VEGE 033 as live lactic acid bacteria was added to the chamber, followed by fermentation, thereby producing a live lactic acid bacteria-containing fermentation broth (coconut vegan yogurt). The live lactic acid bacteria-containing fermentation broth was subjected to first heat treatment (once, step S200) at 80° C. for 10 minutes, thereby producing coconut vegan yogurt.

Sterilization by the first heat treatment was performed in a water bath after packaging the coconut vegan yogurt in a standing pouch made of polyethylene.

### Example 2: Production of Heat-Killed Lactic Acid Bacteria-Containing Fermentation Broth (Step S200, Performed Twice Sequentially)

Coconut cream as a yogurt raw material was placed in a chamber, and Dupont's Danisco VEGE 033 as live lactic acid bacteria was added to the chamber, followed by fermentation, thereby producing a live lactic acid bacteria-containing fermentation broth (coconut vegan yogurt). The live lactic acid bacteria-containing fermentation broth was heat-treated (first step of step S200) at 80° C. for 10 minutes, and the live lactic acid bacteria-containing fermentation broth heat-treated at 80° C. for 10 minutes subjected to second heat treatment (second step of step S200) at 90° C. for 20 minutes, thereby producing coconut vegan yogurt. That is, the first heat treatment in step S200 was performed twice, and sterilization by the two-step heat treatment was performed in a water bath after packaging the coconut vegan yogurt in a standing pouch made of polyethylene.

### Comparative Example 1

Coconut vegan yogurt was produced in the same manner as in Example 1, except that the first heat treatment was not performed. The produced coconut vegan yogurt was referred to as Comparative Example 1.

### Comparative Example 2

Coconut vegan yogurt was produced in the same manner as in Example 1, except that the first heat treatment was performed at 70° C. for 120 minutes. The produced coconut vegan yogurt was referred to as Comparative Example 2.

### Comparative Example 3

Coconut vegan yogurt was produced in the same manner as in Example 1, except that the first heat treatment was performed at 75° C. for 30 minutes. The produced coconut vegan yogurt was referred to as Comparative Example 3.

### Comparative Example 4

Coconut vegan yogurt was produced in the same manner as in Example 1, except that the first heat treatment was performed at 75° C. for 60 minutes. The produced coconut vegan yogurt was referred to as Comparative Example 4.

### Comparative Example 5

Coconut vegan yogurt was produced in the same manner as in Example 1, except that the first heat treatment was performed at 90° C. for 60 minutes. The produced coconut vegan yogurt was referred to as Comparative Example 5.

### Comparative Example 6

Coconut vegan yogurt was produced in the same manner as in Example 1, except that the first heat treatment was performed at 90° C. for 120 minutes. The produced coconut vegan yogurt was referred to as Comparative Example 6.

### Comparative Example 7

Coconut vegan yogurt was produced in the same manner as in Example 1, except that the first heat treatment was performed at 121° C. for 15 minutes. The produced coconut vegan yogurt was referred to as Comparative Example 6.

Evaluation of Appearance, pH, Taste, Bacterial Count, and Viscosity of Coconut Vegan Yogurt

The number of bacteria in each coconut vegan yogurt was measured by culturing using a pour plate method under GAS pack-based anaerobic conditions at 35° C. for 48 to 72 hours.

FIG. 2 shows photographs of Comparative Example 1, Example 1, and Comparative Example 7.

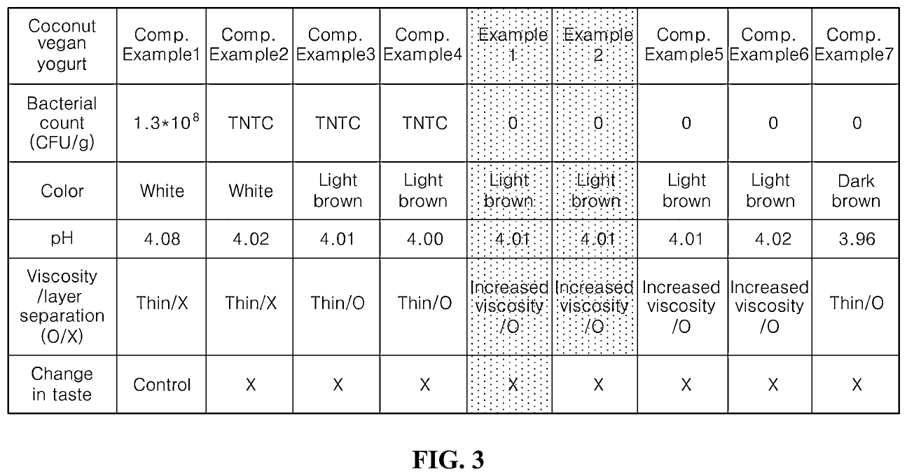

FIG. 3 is a table comparing the appearances, pHs, tastes, bacterial counts, and viscosities of Examples 1 and 2 and Comparative Examples 1 to 7.

Referring to FIG. 3, it can be seen that, in the case of Comparative Examples 2 to 4, as the bacteria remained in the fermented yogurt broth, complete killing of the live lactic acid bacteria by the first heat treatment was not achieved, and in the case of Example 1, Example 2 and Comparative Examples 5 to 7, complete killing of the live lactic acid bacteria by the first heat treatment was achieved.

In addition, it can be seen that, in the case of Comparative Examples 2 to 4 and Comparative Example 7, the viscosity of the coconut vegan yogurt was thin, and in the case of Examples 1 and 2 and Comparative Examples 5 and 6, the coconut vegan yogurt had an increased viscosity suitable for commercialization thereof.

In addition, it can be seen that, in the case of Comparative Example 7, the color changed to a darker color unsuitable for commercialization than Examples 1, 2, and Comparative Examples 1 to 6. In addition, in the case of Example 1, Example 2, and Comparative Examples 1 to 7, it can be confirmed that no change in taste occurred. In addition, it can be seen that, in the case of Example 1, Example 2, and Comparative Examples 1 to 7, no change in taste occurred.

In addition, it can be seen that, in the case of Example 1 and Example 2, the pH was 4.01, which satisfies the condition for a shelf life of 1 year or more, and the pH was generally similar to those of Comparative Example 5 and Comparative Example 6.

Evaluation of Component Changes in Coconut Vegan Yogurt that has been Heat-Treated Once or Twice Compared to Those in Coconut Vegan Yogurt that has not been Heat-Treated (Nine Major Nutritional Components)

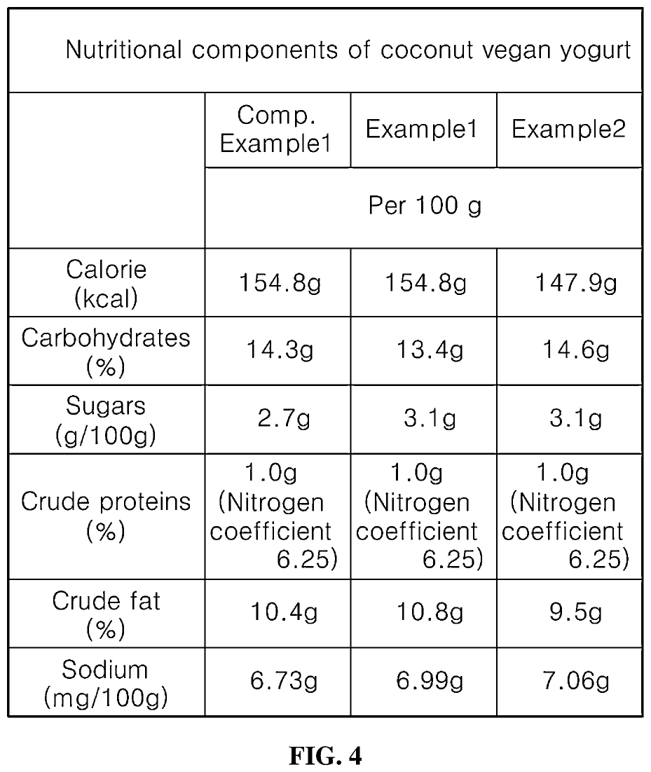

Here, the two-step heat treatment means that the heat treatment in step S200 was performed twice sequentially. FIG. 4 is a table showing the results of measuring the components of Comparative Example 1, Example 1 (heat-treated once), and Example 2 (heat-treated twice).

Referring to FIG. 4, it can be seen that, in the case of Comparative Example 1, Example 1, and Example 2, no significant changes in nutritional components occurred.

That is, it can be seen that the nutritional components in the coconut vegan yogurt subjected to the one-step or two-step heat treatment in step S200 did not differ from the nutritional components of the general coconut vegan yogurt that was not subjected to heat treatment.

Evaluation of Component Changes (Nine Major Nutritional Components, pH, Sugar Content, Bacterial Count, and Fungal Count)

Here, the one-step heat treatment means that the heat treatment in step S200 was performed once. In addition, refrigerated storage means storage at a temperature of, for example, 0° C. to 10° C., and the room-temperature storage means storage at a temperature of 1° C. to 35° C.

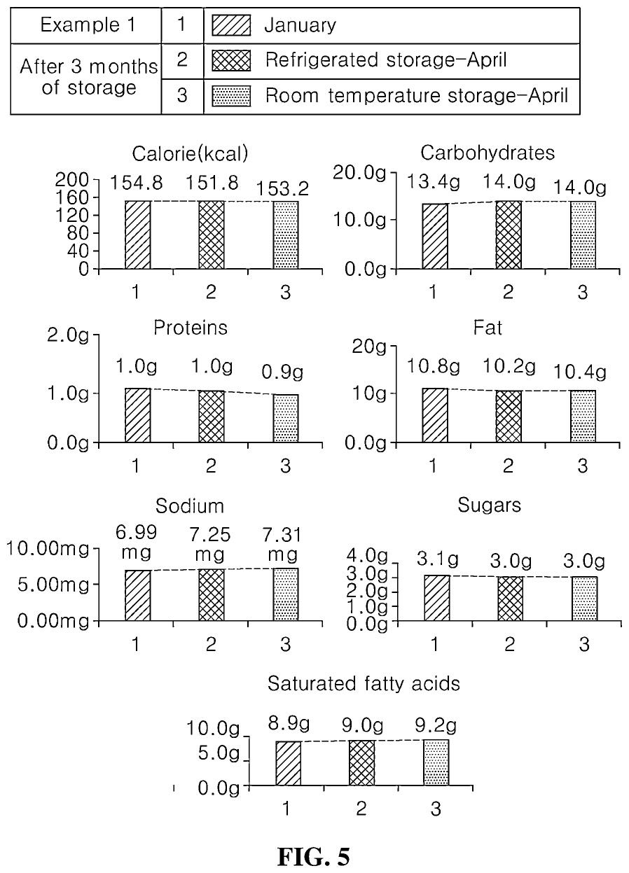

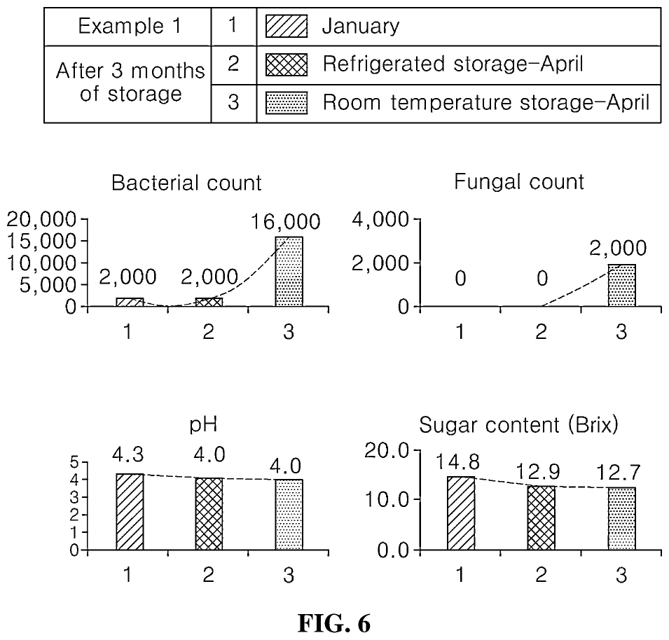

FIGS. 5 and 6 are graphs showing changes in each component after preparing a sample of Example 1 by performing the heat treatment in step S200 once and then and storing the sample of Example 1 under refrigeration and room temperature conditions for 3 months.

Referring to the figures, it can be seen that there was no significant difference in the contents of nutritional components, including calories, carbohydrates, sugars, proteins, saturated fatty acids, and sodium, in each case.

In addition, it can be seen that, after one-step heat treatment and 3 months of refrigerated storage, there was no significant change in pH, sugar content, bacterial count, and fungal count, but after 3 months of storage at room temperature for 3 months, both the bacterial count and the fungal count increased rapidly.

Thereby, it was confirmed that, when the sample of Example 1 was stored refrigerated for 3 months, no abnormality occurred, indicating that the stability of the product could be ensured, but when the sample of Example 1 was stored at room temperature for 3 months, the bacterial count and the fungal count increased rapidly, indicating that the stability of the product could not be ensured.

That is, it was confirmed that, when the sample of Example 1 was stored refrigerated for 3 months, food hygiene safety could be ensured, but when the sample of Example 1 was stored at room temperature, it was confirmed that food hygiene safety could not be ensured.

Evaluation of Component Changes (Nine Major Nutritional Components, pH, Sugar Content, Bacterial Count, and Fungal Count) after 3 Months of Room-Temperature and Refrigerated Storage after Production of Coconut Vegan Yogurt Through Two-Step Heat Treatment

Here, the two-step heat treatment that the heat treatment in step S200 was performed twice sequentially.

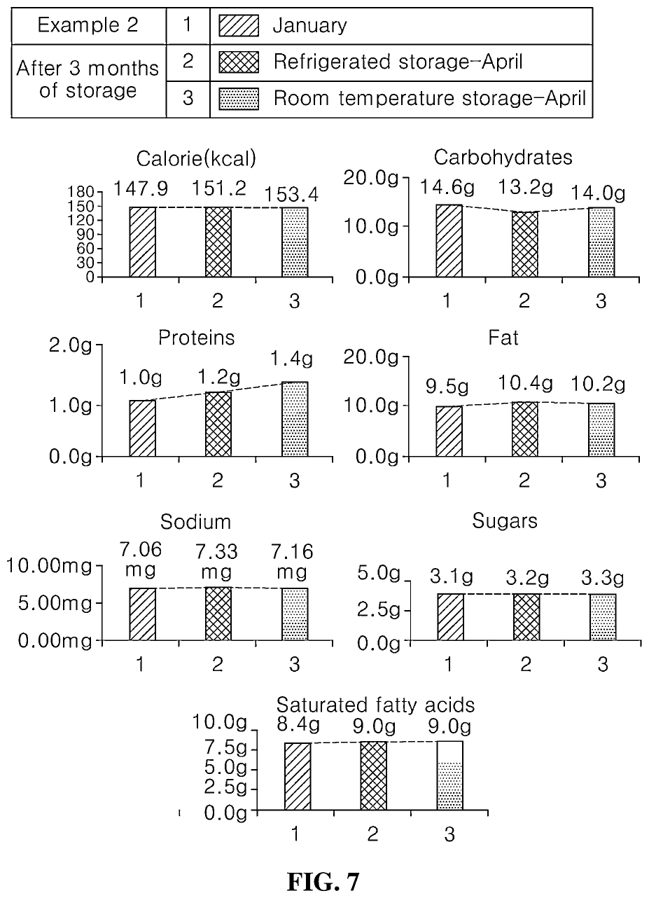

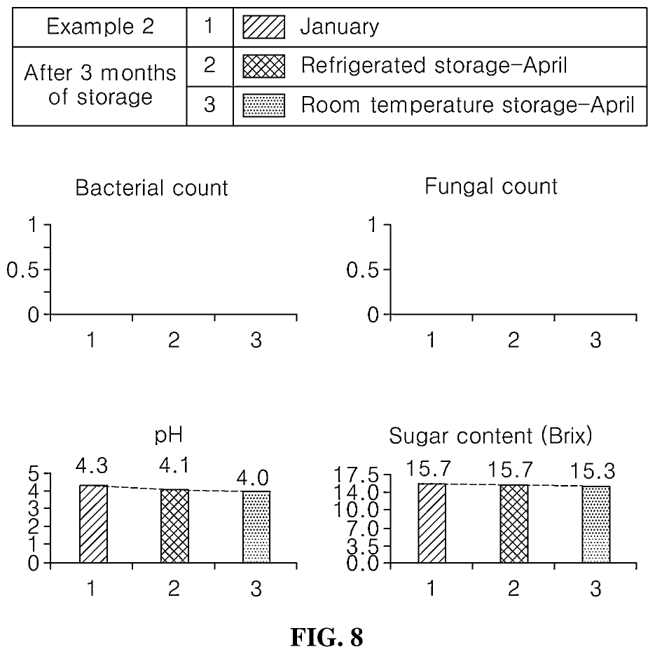

FIGS. 7 and 8 are graphs showing changes in each component after preparing a sample of Example 2 by performing the heat treatment in step S200 twice and then and storing the sample of Example 2 under refrigeration and room temperature conditions for 3 months.

Referring to the figures, it can be seen that there was no significant difference in the contents of nutritional components, including calories, carbohydrates, sugars, proteins, saturated fatty acids, and sodium, in each case, like the case of the one-step heat treatment.

In addition, it can be seen that, after two-step heat treatment and 3 months of refrigerated storage, there was no significant change in pH, sugar content, bacterial count, and fungal count. Similarly, it can be seen that, after 3 months of storage at room temperature, there was no significant change in pH, sugar level, bacterial count, and fungal count.

Thereby, it was confirmed that, when the sample of Example 2 was stored refrigerated for 3 months, there was no increase in the bacterial count and the fungal count, indicating that the stability of the product could be ensured In summary, it can be confirmed that the yogurt product produced by performing the heat treatment in step S200 twice was stable not only during 3 months of refrigerated storage but also 3 months of storage at room temperature.

The present applicant confirmed the above results by conducting the test for 3 months due to time constraints, and these data can substantially match a room-temperature shelf life of at least 6 months, preferably 1 year or more, which is claimed in the present invention. Although the present invention has been shown and described in relation to preferred embodiments for illustrating the principles of the present invention, the present invention is not limited to the configuration and operation as shown and described. Rather, it will be appreciated by those skilled in the art that many changes and modifications to the present invention may be made without departing from the spirit and scope of the appended claims.

### INDUSTRIAL APPLICABILITY

The present invention provides a method for producing yogurt, which is capable of solving distribution and storage problems by dramatically overcoming the limitation of short shelf life under refrigerated storage conditions of existing yogurt, specifically, increasing the shelf life at room temperature (not refrigeration) of yogurt to at least 6 months, preferably about 1 year, while maintaining the taste, nutritional components, and special features of existing yogurt, through a process of fermenting a raw material using live lactic acid bacteria and killing the live lactic acid bacteria by heat treatment, and yogurt produced by the method.

1. A method for producing yogurt comprising steps of:
(a) producing a live lactic acid bacteria-containing fermentation broth by adding live lactic acid bacteria to a yogurt raw material and fermenting the yogurt raw material; and
(b) producing a killed bacteria-containing fermentation broth by killing the live lactic acid bacteria through a process of heat-treating the live lactic acid bacteria-containing fermentation broth at least once.

2. The method of claim 1, wherein the heat treatment is performed within a range of temperature and time conditions in which no change in nutritional components of the live lactic acid bacteria-containing fermentation broth occurs.

3. The method of claim 1, wherein the heat treatment in step (b) is performed at a temperature of 80° C. to 100° C. for 10 minutes to 40 minutes.

4. The method of claim 1, wherein the heat treatment in step (b) is performed at least twice sequentially.

5. The method of claim 1, wherein the yogurt raw material is milk or a vegetable milk substitute including at least one of coconut cream and soy milk.

6. The method of claim 1, wherein step (b) is performed in a state in which the live lactic acid bacteria-containing fermentation broth is accommodated in a chamber so that it is protected from contact with external air, and the method further comprises, after step (b), a step of stirring the killed bacteria-containing fermentation broth in the chamber.

7. The method of claim 1, further comprising, after step (b), step (c) of additionally heat-treating the killed bacteria-containing fermentation broth in a state in which only the killed bacteria-containing fermentation broth is packaged in an individual container, or additionally heat-treating a mixture of the killed bacteria-containing fermentation broth and a fruit additive in a state in which the mixture is packaged in an individual container.

8. The method of claim 7, wherein the heat treatment in step (c) is performed at a temperature of 80° C. to 95° C. for 10 minutes to 40 minutes.

9. The method of claim 7, wherein step (c) is performed in a state in which a predetermined amount of killed bacteria are added to the individual container.

10. Yogurt produced by the method of claim 1.

11. Yogurt produced by the method of claim 7.
